(19) United States
(12) Patent Application Publication
(10) Pub. No.: US 2002/0041598 A1
(43) Pub. Date: Apr. 11, 2002

(54) Control device and method for a local and non-local communications device connected to a network

(76) Inventors: Heike Hecker, Wiesloch (DE); Thomas Hecker, Wiesloch (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/950,439

(22) Filed: Sep. 10, 2001

(30) Foreign Application Priority Data
Sep. 8, 2000 (DE) 100 44 692.2

(51) Int. Cl. H04L 12/28

(52) U.S. Cl. 370/401; 370/420; 370/463

(57) ABSTRACT

A device for initiating a transmission of data from a non-local communications device to a local communications device connected via a network to the non-local communications device, the transmission-initiating device comprising an interface with the local communications device, at least one information storage medium containing locally and non-locally relevant information, and a control element, the interface being disconnectable and, when the control element is being operated, the transmission-initiating device serving for generating at least one control signal for the local communications device, and for transmitting locally and non-locally relevant information to the local communications device; and a method of operating the transmission-initiating device.

### BACKGROUND OF THE INVENTION

### Field of the Invention

The invention relates to a device and method for initiating a transmission of data from a non-local communications device to a local communications device connected via a network to the non-local communications device, having an interface with the local communications device, having at least one information storage medium containing locally and non-locally relevant information, and having an operating element.

Typical advertising measures in the field of telecommunications have an interrupted information chain between producers or providers and recipients or potential customers of classical advertising media and telecommunications applications. In advertising campaigns, advertising measures or sales demonstrations, we are frequently informed by advertising media, such as journals, brochures, advertisements, prospectuses, catalogues, advertising letters, fliers, bill posters, customer journals or the like, of products, in which certain information, for example, a domain name or an Internet address, is quoted to which appropriate applications can be found in a non-local network of communications devices. The communications devices may be computers, telephones, mobile phones, televisions, radios, palmtop computers or the like, which are linked in a network, which may be electronic, optical or wire-free, for information transmission between the individual nodes, the non-locally distributed communications devices. In this context, the term applications means any type of information that is passed on, such as texts, information, masks, application programs, films, audio or visual information or e-commerce applications or the like. The advertising messages which refer to the products or to applications linked thereto are received by the recipient or potential customer and are carried away or are written down or noted autonomously on an advertising medium, for example, in the form of an advertising leaflet.

A local communications device, which is connected to the network of non-local communications devices, allows such products or applications which are linked thereto to be retrieved, via a connection for interchanging data and/or control signals, for the recipient or potential customer. Typically, certain control or operating programs are called up for long-distance data transmission via the appropriate keyboard, which is provided by the manufacturer of the local communications device, via menu-controlled instructions, manual inputting of information or user-controlled operation of other input elements such as a mouse, a track ball, a light pen or the like.

It has become known heretofore that the operation of a control element can control a range of functions and sequences within the local communications device and the non-local communications devices in the network, and that control devices can be constructed for a desired purpose.

In the published European Patent Document EP 0 964 328 A2, a computer system is disclosed which allows rapid access to preconfigured Internet sites. Keys are provided on a keyboard or a similar input unit and, when operated, generate unambiguous Internet access signals. A signal processing unit connects the computer system to the non-local computer at the Internet site, and appropriate application software is started, if necessary, in order, for example, to set up e-commerce or connections for sending e-mails. When the appropriate keys are operated, a user can rapidly access a non-local computer in the network and can then carry out appropriate operations, such as downloading or loading user-related data, without having to navigate through a range of menus or windows on a monitor.

Such a device has the disadvantage, particularly with regard to use as an advertising medium, that the keys provided for calling the preconfigured Internet sites are integrated in the keyboard of the local communications device, or in some similar input unit. Typically, the functions of these keys are permanently stored by the keyboard manufacturer, although they are generally programmable.

U.S. Pat. No. 5,865,546 describes a modular keyboard which allows individual modules to be inserted into recesses provided in a base chassis having guides and stops, and to make them available by interfaces for data connection, i.e., for producing an electrical contact between the modules and the base chassis. Users can interchange or replace each individual keyboard module by another. A monitoring unit is provided in the base chassis for determining the nature of the module which is coupled via a specific connection interface.

Such a device has the disadvantage that the control elements for the individual key modules have only one predetermined function for the local communications device.

In order to allow applications to be used in a local communications device, the user typically has to learn a number of steps which are specific to the local communications device. A time-consuming procedure for switching on the appropriate local communications device is normally followed by a manual input procedure for addresses, and this is generally associated with tediously clicking hierarchically through the corresponding keyboard. A further option is a specific search for an application in the network of non-local communications devices by an instruction or search engines, which are used by the recipient or potential customer and have been entered via domains or Internet addresses in the information provided with the advertising message. In particular, for lay persons, the elderly and recipients or potential customers who are unfamiliar with the procedure, it is unreasonable to expect that they will remember how an application can be called from a network of non-local communications devices, only in abstract form, in graphic form or in written form. A control element such as that disclosed in the aforementioned published European Patent Document EP 0 964 328 A2 is, however, not mobile on the advertising medium together with the advertising message.

### SUMMARY OF THE INVENTION

It is accordingly an object of the invention to provide a device and method for initiating the transmission of data from a non-local communications device to a local communications device, the transmission-initiating device being mobile in comparison with the local communications device, together with an advertising message, or the information regarding the location of a specific application in a network of non-local communications devices, by a simple control element which can be used quickly by anyone without any prior knowledge.

With the foregoing and other objects in view, there is provided, in accordance with one aspect of the invention, a device for initiating a transmission of data from a non-local communications device to a local communications device connected via a network to the non-local communications device, the transmission-initiating device comprising an interface with the local communications device, at least one information storage medium containing locally and non-locally relevant information, and a control element, the interface being disconnectable and, when the control element is being operated, the transmission-initiating device serving for generating at least one control signal for the local communications device, and for transmitting locally and non-locally relevant information to the local communications device.

In accordance with another feature of the invention, the locally relevant information includes at least one of control signals and commands for initiating a start of application programs.

In accordance with a further feature of the invention, the non-locally relevant information includes one of an address and a domain name of a non-local communications device in the network.

In accordance with an added feature of the invention, the locally relevant information includes at least one of a control signal and a control command for starting an application program in the network.

In accordance with an additional feature of the invention, the information storage medium is programmable.

In accordance with yet another feature of the invention, the interface has at least one wire-free section.

In accordance with yet a further feature of the invention, the device for initiating a transmission of data from a non-local communications device to a local communications device includes a display.

In accordance with yet an added feature of the invention, the device for initiating a transmission of data from a non-local communications device to a local communications device includes at least one of a surface and a shape provided on the transmission-initiating device for at least one of an ergonomic, an esthetic and an advertising purpose.

In accordance with yet an additional feature of the invention, the device for initiating a transmission of data from a non-local communications device to a local communications device includes at least one first and one second part connected to one another via an interface, the first part comprising the information storage medium, and the second part being an insert element.

In accordance with still another feature of the invention, the interface between the first and the second part has at least one wire-free section.

In accordance with still a further feature of the invention, the data transmittable from the network contains information relevant for controlling a machine.

In accordance with still an added feature of the invention, the data transmittable from the network contains information comprising parameters for adjusting a machine.

In accordance with a concomitant aspect of the invention, there is provided a method for transmitting data from a non-local communications device in a network to a local communications device having a device for initiating a transmission of data from the non-local communications device to the local communications device connected via the network to the non-local communications device, which comprises transmitting a signal from the transmission-initiating device to the local communications device, interchanging control signals between the local communications device and a non-local communications device, transferring data from a non-local communications device to the local communications device, and transmitting information with non-local relevance from the transmission-initiating device to the local communications device.

The device according to the invention for initiating the transmission of data from a non-local communications device to a local communications device, which is connected via a network to the non-local communications device, thus has an interface with the local communications device, at least one information storage medium which contains locally and non-locally relevant information, and a control element.

According to the invention, an interface which can be disconnected is provided, so that the device can be mobile and can be moved to another location independently of the local communications device. When the control element is operated, at least one control signal is generated for the local communications device, and locally and non-locally relevant information is transmitted from the device to the local communications device. The locally relevant information advantageously comprises the starting of application programs, such as programs which allow long-distance data transmission, and non-locally relevant information, such as addresses of non-local communications devices in the network.

The transmission of data from a non-local communications device to a local communications device comprises not only the transmission of a signal from the device according to the invention to the local communications device but also the transmission of information with non-local relevance from the device according to the invention to the local communications device, interchange of control signals between the local communications device and a non-local communications device, and data transfer from a non-local communications device, which is not necessarily the same one, to the local communications device. The non-locally relevant information may likewise comprise control signals or control commands, which initiate the starting of application programs in the network.

For example, the device according to the invention makes it possible to open an Internet site, to initiate the running of an advertising film on the local communications device or to call up an interactive form that is to be completed, or the like.

The use of the device according to the invention and the use of the method result in a number of advantages.

In particular, using the device according to the invention, it is possible to access applications, which are located in a non-local communications device in a network, quickly and directly. The device can be passed as an advertising medium from a producer or provider to a recipient or potential customer and, in this regard, carries both the abstract information about the telecommunications application and a simple control element by which, without any special prior knowledge, this information can be used in order to access further applications. It is particularly advantageous, in this regard, that the recipient or potential customer need carry out only one step in order to call such applications up, once the device has been connected to the local communications device via the interface which can be disconnected. In other words, the large number of control steps which are typically required for accessing an application via the local communications device on the non-local communications device are reduced, because the information chain for the recipient or potential customer from the advertising medium, via the advertising message and the communications device to the application, has not been unnecessarily interrupted. This avoids advertising losses because it facilitates the operation of the local communications device for the recipient or potential customer, so that an improved success rate can be expected for complex and costly advertising campaigns.

Other features which are considered as characteristic for the invention are set forth in the appended claims.

Although the invention is illustrated and described herein as embodied in a control device and method for a local and non-local communications device which is connected to a network, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, wherein:

### BRIEF DESCRIPTION OF THE DRAWINGS

FIG. 1 is a schematic diagram showing the topology of the device according to the invention, a local communications device and a network of non-local communications devices which are connected to one another;

FIG. 2A is a diagrammatic top plan view of a particular embodiment of the device according to the invention, with a display and an advertising-medium surface;

FIG. 2B is a diagrammatic top, front and side perspective view of an alternative embodiment of the device according to the invention having a three-dimensional surface;

FIG. 3 is a diagrammatic top plan view of another embodiment of the invention provided with an advantageous improvement in the form of an insertable switching element; and

FIG. 4 is a view like that of FIG. 3 of a further embodiment of the invention, having, as an advantageous development or improvement thereof, a number of control or operating elements.

### DESCRIPTION OF THE PREFERRED EMBODIMENTS

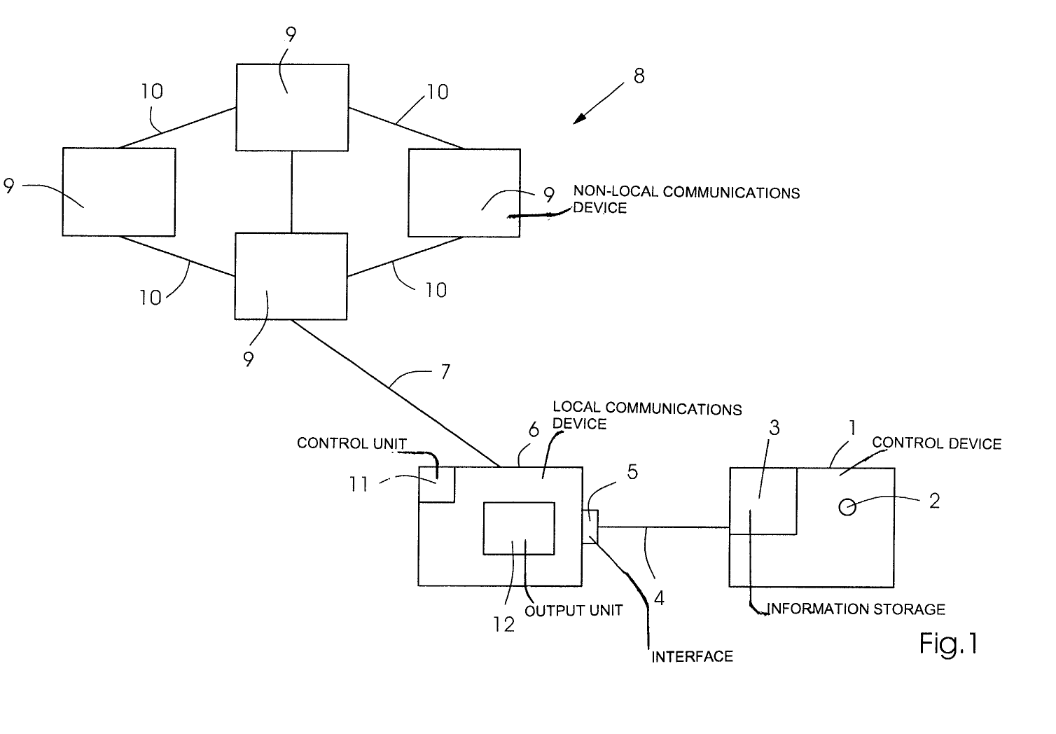

Referring now to the drawings and, first, particularly to FIG. 1 thereof, there is shown therein, schematically, the topology of a control device 1 according to the invention, a local communications device 6 and a network 8 of non-local communications devices 9 which are connected to one another. The control device 1 according to the invention has a control element, preferably a switch, joystick, lever or the like, which generates, when operated, at least one control signal. Furthermore, the control device 1 has at least one information storage medium 3, typically a permanently programmed or programmable memory medium, advantageously a magnetic data storage medium 3, connected to appropriate electronics for controlling input/output procedures, in particular. The control device 1 makes contact with the local communications device 6 by a connection 4 for interchanging data and/or control signals. For this purpose, an interface 5 is provided, which, in the case of a fixed connection or link 4, advantageously complies with the typical Standards, for example, the so-called RS 232 interface.

The control device 1 according to the invention thus represents an address transmitter or an information transmitter, which is connected to a local communications device 6, which receives the information, in particular domain names or Internet addresses. The connection 4, in this regard, can be produced by a line connection, as shown in FIG. 1, or else, in an advantageous development or improvement, has at least one wire-free section, for example an infrared transmission path. In a further advantageous development, the control device 1 according to the invention can also be brought directly into physical contact with the local communications device 6 by, for example, inserting the control device 1 into a recess provided for this purpose.

The control device 1 serving as an address transmitter thus contains information in stored form which is relevant for the local communications device, as well as information which is relevant for the non-local communications device. In this regard, in particular, information about the location, domain name or Internet address of specific applications in a network, is involved. In an advantageous development, this may also include a range of information contents which differ from one another. In a further advantageous development of the invention, at least a part of an application program, or at least one complete application program, is also stored in the memory medium 3 of the control device 1 according to the invention, which is either transferred to the local communications device 6 before being executed, or can be executed directly by the local communications device 6 by accessing the memory medium 3.

The local communications device 6 makes contact, via a connection for interchanging data and/or control signals, with a network 8 which has at least one non-local communications device 9, four of such devices 9 being illustrated here by way of example, the non-local communications devices 9 being, in turn, connected by respective connections 10 for interchanging data and/or control signals. When the control element 2, which is typically in the form of a switch, is operated, the control device 1 generates at least one control signal so that the local communications device 6 accesses the information which is stored in the information storage medium 3 in the control device 1, and which has local and non-local relevance. The local communications device 6, which typically has at least one control unit 11 and an output unit 12 that is typically a monitor or a printer, starts certain programs for long-distance data transmission in order to access a non-local communications device 9 in the network 8 by the information provided by the control device 1 concerning the location of certain applications. Data and/or control signals are interchanged via the connection 7 between the local communications device 6 and the network 8.

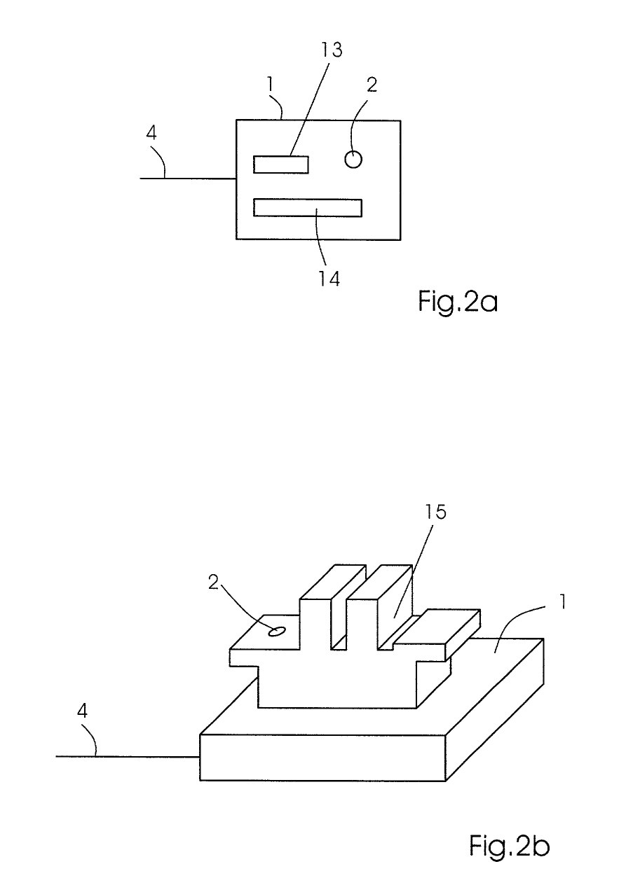

FIGS. 2A and 2B diagrammatically show preferred embodiments of the device according to the invention. FIG. 2A shows one possible embodiment of the device according to the invention, which has a display 13 and a shaped surface 14. Appropriate additional information, which is made available on the information storage medium 3 by the control device 1 or else has been obtained from the local or one of the non-local communications devices 6 or 9, respectively, can be provided on the display 13. At least a part of the control device 1 can be shaped for ergonomic and/or esthetic reasons. Advantageously, a shaped advertising surface 14 is involved. The control device 1 is connected, by the connection 4 for interchanging data and/or control signals, to a local communications device, which is not shown in FIGS. 2A and 2B.

FIG. 2B shows an alternative embodiment of the device according to the invention. A part of the control device 1, which makes contact with a local communications device (not shown in FIG. 2B) by the connection 4 for interchanging data and/or control signals, may also be three-dimensional. Advantageously, this is an ergonomically and/or esthetically pleasing shape 15. In particular, this may be a shaped model of a symbol of a machine, for example, a printing machine, i.e., it can be designed for advertising purposes. For example, the three-dimensional shape 15 may also be a product card, in particular a music card or a speech card, i.e., a card formed as an advertising medium. In the case of a music card or speech card, audio information is transmitted from the non-local communications device to the local information device by the device according to the invention.

A three-dimensional shape 15 may have the function of an advantageous study object for education, instruction and training, in particular, for a machine. By operating or touching the three-dimensional shape 15 at various locations, a multimedia application can be transmitted from the non-local communications device 9 to the local communications device 6, so that complex situations, such as those relating to machine operation, can be displayed.

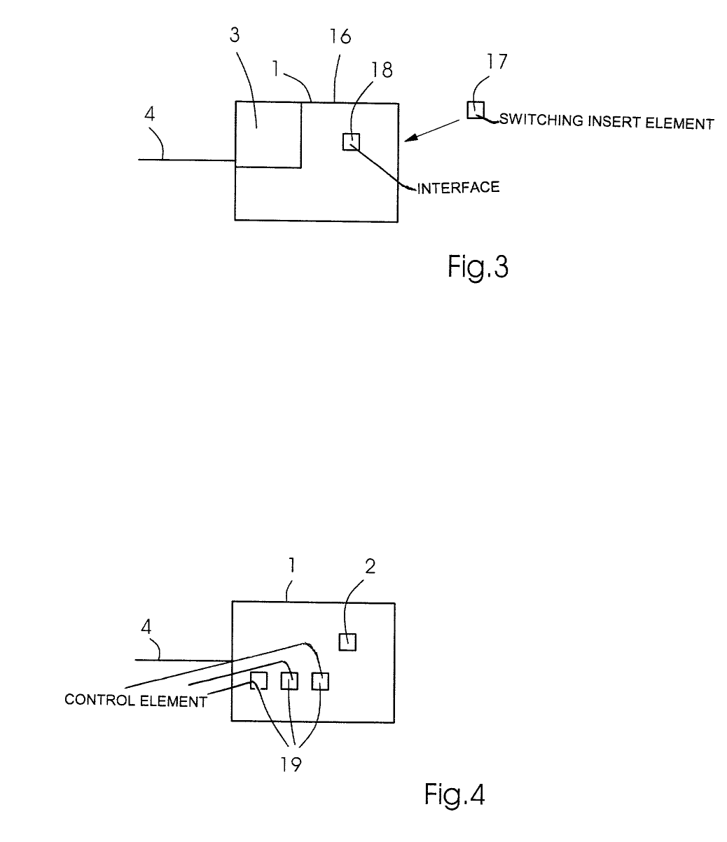

FIG. 3 shows an advantageous development of the invention. The control device 1 in this case has at least two parts. The first part is a base chassis 16, which contains the information storage medium 3 for the control device 1. The second part is an insert element 17, for which an interface 18 is provided in the base chassis 16. The insert element 17 may, for example, be a switch, a lever, a card or some other information storage medium. By way of example, the interface 18 produces or interrupts an electrical or optical contact between the switching element 17 and the information storage medium 3 in the base chassis 16. In an advantageous development or improvement, the insert element 17 may also have a programmable or permanently programmed memory, which interacts with the information storage media 3 in the base chassis 16 to provide the information with local or non-local relevance for the local communications device 6, or at least one of the non-local communications devices 9. In other words, the insert element 17 can be constructed so that it has parts of or entire devices which carry out or initiate functions of the control element 1.

In another advantageous development, the insert element 17 and the associated interface 18 can be constructed so that insert elements 17 having different functions can be connected to the base chassis 16, with the result that different information can be provided by the control device 1 for the local communications device 6. This may relate, in particular, to a number of addresses, and to location information for specific applications in non-local communications devices 9 in the network 8. In a further advantageous development, the interface 18 between the insert element 17 and the base chassis 16 may also have at least one wire-free section.

A further development of the device according to the invention, as shown in principle in FIG. 3, individual adaptation to the user of the local communications device is allowed, easily and in a simple manner. The insert element 17 may include all or at least some of the prerequisites for use of the control device 1.

FIG. 4 shows an advantageous development of the invention, wherein a number of different control elements 19 are provided. The control device 1 which makes contact with a local communications device (not shown here) by the connection for interchanging data and/or control signals, in this case has not only the control element 2, but also, a number of further control elements 19, such as switches or levers, for example. When at least one of the control elements 19 is operated or actuated, at least one control signal is generated for the local communications device. Typical functions which can be initiated by the operation of one of these control elements 19 are printing, the calling up of different Internet sites or the calling up of a specific application, such as the sending of electronic messages or orders, e-mail or e-commerce applications. It is self-evident that the individual control elements 19 can be tailor-made individually for the user of the local communications device 6.

The control device 1 according to the invention is suitable for deliberate selection and connection of non-local communications devices 9 to a recipient, to a customer or to a potential customer quickly and conveniently, because the control device 1 according to the invention includes an address transmitter or information transmitter. The control device 1 according to the invention can be constructed individually for a specific target group, i.e., it can increase the customer's involvement with the producer or provider. A control device 1 constructed for advertising purposes is suitable, for example, for marketing methods and marketing actions for various products. Furthermore, the customer support by the producer or provider can advantageously be improved. The data transmitted from the network 8 of non-local communications devices 9 advantageously includes information which is relevant to the control or operation of a product, for example, of a machine. In particular, the information may, in this regard, include parameters for machine adjustment.

Furthermore, it is also possible for the effect or useful life of the device according to the invention to be restricted. For example, it is possible to provide for a key for verification of the access or usage authorization to be stored in or on the information storage medium 3, which varies the validity thereof after a predetermined time period has elapsed. Furthermore, data that is relevant for known cryptographic methods, such as key information, can be stored in or on the information storage medium 3. Such keys may allow multiple use, or may be a key for single use.

We claim:

1. A device for initiating a transmission of data from a non-local communications device to a local communications device connected via a network to the non-local communications device, the transmission-initiating device comprising an interface with the local communications device, at least one information storage medium containing locally and non-locally relevant information, and a control element, said interface being disconnectable and, when said control element is being operated, the transmission-initiating device serving for generating at least one control signal for the local communications device, and for transmitting locally and non-locally relevant information to the local communications device.

2. The device for initiating a transmission of data from a non-local communications device to a local communications device according to claim 1, wherein said locally relevant information includes at least one of control signals and commands for initiating a start of application programs.

3. The device for initiating a transmission of data from a non-local communications device to a local communications device according to claim 1, wherein said non-locally relevant information includes one of an address and a domain name of a non-local communications device in the network.

4. The device for initiating a transmission of data from a non-local communications device to a local communications device according to claim 1, wherein said non-locally relevant information includes at least one of a control signal and a control command for starting an application program in the network.

5. The device for initiating a transmission of data from a non-local communications device to a local communications device according to claim 1, wherein said information storage medium is programmable.

6. The device for initiating a transmission of data from a non-local communications device to a local communications device according to claim 1, wherein said interface has at least one wire-free section.

7. The device for initiating a transmission of data from a non-local communications device to a local communications device according to claim 1, including a display.

8. The device for initiating a transmission of data from a non-local communications device to a local communications device according to claim 1, including at least one of a surface and a shape provided on the transmission-initiating device for at least one of an ergonomic, an esthetic and an advertising purpose.

9. The device for initiating a transmission of data from a non-local communications device to a local communications device according to claim 1, including at least one first and one second part connected to one another via an interface, said first part comprising said information storage medium, and said second part being an insert element.

10. The device for initiating a transmission of data from a non-local communications device to a local communications device according to claim 9, wherein said interface between said first and said second part has at least one wire-free section.

11. The device for initiating a transmission of data from a non-local communications device to a local communications device according to claim 1, wherein said data transmittable from said network contains information relevant for controlling a machine.

12. The device for initiating a transmission of data from a non-local communications device to a local communications device according to claim 1, wherein said data transmittable from said network contains information comprising parameters for adjusting a machine.

13. A method for transmitting data from a non-local communications device in a network to a local communications device having a device for initiating a transmission of data from the non-local communications device to the local communications device connected via the network to the non-local communications device, which comprises transmitting a signal from the transmission-initiating device to the local communications device, interchanging control signals between the local communications device and a non-local communications device, transferring data from a non-local communications device to the local communications device, and transmitting information with non-local relevance from the transmission-initiating device to the local communications device.
